(19) United States
(12) Patent Application Publication
(10) Pub. No.: US 2017/0118079 A1
(43) Pub. Date: Apr. 27, 2017

(54) PROVISIONING COMPUTER RESOURCES TO A GEOGRAPHICAL LOCATION BASED ON FACIAL RECOGNITION

(71) Applicant: INTERNATIONAL BUSINESS MACHINES CORPORATION, Armonk, NY (US)

(72) Inventors: Aaron K. Baughman, Silver Spring, MD (US); Cameron McAvoy, Raleigh, NC (US); Brian M. O'Connell, Cary, NC (US); Herbert D. Pearthree, Cary, NC (US)

(21) Appl. No.: 14/922,118

(22) Filed: Oct. 24, 2015

(51) Int. Cl. H04L 12/24; G06K 9/62; G06K 9/00; G06K 9/66; H04L 29/08; H04L 12/58

(52) U.S. Cl. CPC H04L 41/0889; H04L 67/18; H04L 51/32; H04L 41/0806; G06K 9/00288; G06K 9/00228; G06K 9/66; G06K 9/00315; G06K 9/6201

(57) ABSTRACT

A provisioning mechanism performs facial recognition of a photograph, and determines when the person corresponding to the recognized face is correlated to a desired geographical location. The availability of resources near the desired geographical location is determined, and computer resources are then provisioned at a resource center near the desired geographical location. The result is provisioning computer resources to a geographical location based on facial recognition.

### BACKGROUND

1. Technical Field

This disclosure generally relates to provisioning computer resources, and more specifically relates to provisioning computer resources to a geographical location based on facial recognition.

2. Background Art

Social media has become a powerful force in our modern world. When something is trending in social media, there is often a need for a corresponding increase in computer resources to support the trend. Thus, if a tennis match at Wimbledon is in play, there may be a need to increase computer resources to support the trending social media corresponding to the tennis match. In fact, there have been instances of social media sites crashing due to a trend that swamps the site's ability to provision computer resources quickly enough.

The issue of where to provision increased computer resources when something on social media is trending has typically been based on an analysis of textual data, annotations, the origin of the trending traffic, and content metadata. For example, if a social media message includes text that references Wimbledon, resources could be provisioned in England at a resource center near Wimbledon.

A problem with known solutions for determining where to provision computer resources is that there may be one or more locations other than the location of the event where additional computer resources should be provisioned. For example, a tennis player from Spain playing in the Wimbledon tennis tournament could create a need for additional resources in Spain due to the locals trending on social media with respect to the player from Spain. None of the known solutions perform facial recognition of photos to determine where to provision computer resources.

### SUMMARY

A provisioning mechanism performs facial recognition of a photograph, and determines when the person corresponding to the recognized face is correlated to a desired geographical location. The availability of resources near the desired geographical location is determined, and computer resources are then provisioned at a resource center near the desired geographical location. The result is provisioning computer resources to a geographical location based on facial recognition.

The disclosure and claims herein support an apparatus comprising: at least one processor; a memory coupled to the at least one processor; a provisioning mechanism residing in the memory and executed by the at least one processor, the provisioning mechanism comprising: a facial recognition mechanism that recognizes a face in a photograph; a face/location correlation mechanism that correlates the face recognized by the facial recognition mechanism to a corresponding first geographical location; a resource availability mechanism that identifies a resource center at a second geographical location that correlates with the first geographical location and has resources available; and a resource provisioning mechanism that provisions at least one resource to the resource center at the second geographical location. This apparatus provides an advantage of provisioning resources at a geographical location based on facial recognition.

The disclosure and claims herein further support an apparatus as recited in the previous paragraph wherein the facial recognition mechanism comprises a neuromorphic processor. Performing facial recognition using a neuromorphic processors provides a significant speed advantage when compared to using traditional Von Neumann techniques for facial recognition.

The disclosure and claims herein further support an apparatus as recited two paragraphs earlier wherein the facial recognition mechanism identifies an emotion from facial expression of the face in the photograph, and the provisioning mechanism determines whether the identified emotion correlates to more or less resources, and when the identified emotion correlates to more resources, the provisioning mechanism provisions at least one additional resource at the second geographical location, and when the identified emotion correlates to less resources, the provisioning mechanism deprovisions at least one resource at the second geographical location. This apparatus provides an advantage of provisioning or deprovisioning resources based on facial expressions of a recognized face.

The disclosure and claims herein further support a computer-implemented method executed by at least one processor for provisioning computer resources and an article of manufacture similar to the apparatus discussed in the preceding paragraphs.

None of the known solutions for provisioning computer resources use facial recognition of a photograph to determine where to provision computer resources. The inventors of the instant application are the first to appreciate the need and utility for provisioning computer resources at a geographical location based on facial recognition in a photograph.

The foregoing and other features and advantages will be apparent from the following more particular description, as illustrated in the accompanying drawings.

### BRIEF DESCRIPTION OF THE DRAWING(S)

The disclosure will be described in conjunction with the appended drawings, where like designations denote like elements, and:

FIG. 1 is a block diagram of a cloud computing node;

FIG. 2 is a block diagram of a cloud computing environment;

FIG. 3 is a block diagram of abstraction model layers;

FIG. 4 is a block diagram showing some features of a cloud provisioning mechanism;

FIG. 5 is block diagram of a method for provisioning resources at a geographical location based on facial recognition;

FIG. 6 is a table that shows correlation between the name of a person and a corresponding preferred location for provisioning computer resources for that person;

FIG. 7 is a flow diagram of a method for provisioning resources at multiple geographical locations based on facial recognition;

FIG. 8 is a table that shows correlation between the name of a person and multiple corresponding preferred locations for that person;

FIG. 9 is a flow diagram of a method for determining number and type of resources to provision at a geographical location based on facial recognition;

FIG. 10 is a flow diagram of a method for deprovisioning resources in a geographical location where the person corresponding to the recognized face is unpopular;

FIG. 11 is a flow diagram of a method for identifying emotion from a facial expression on an identified face and increasing or decreasing resources based on the identified emotion; and

FIG. 12 is a flow diagram of a method for determining and logging correlation between facial expression and demand for resources.

### DETAILED DESCRIPTION

The disclosure and claims herein relate to a provisioning mechanism that performs facial recognition of a photograph, and determines when the person corresponding to the recognized face is correlated to a desired geographical location. The availability of resources near the desired geographical location is determined, and computer resources are then provisioned at a resource center near the desired geographical location. The result is provisioning computer resources to a geographical location based on facial recognition.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

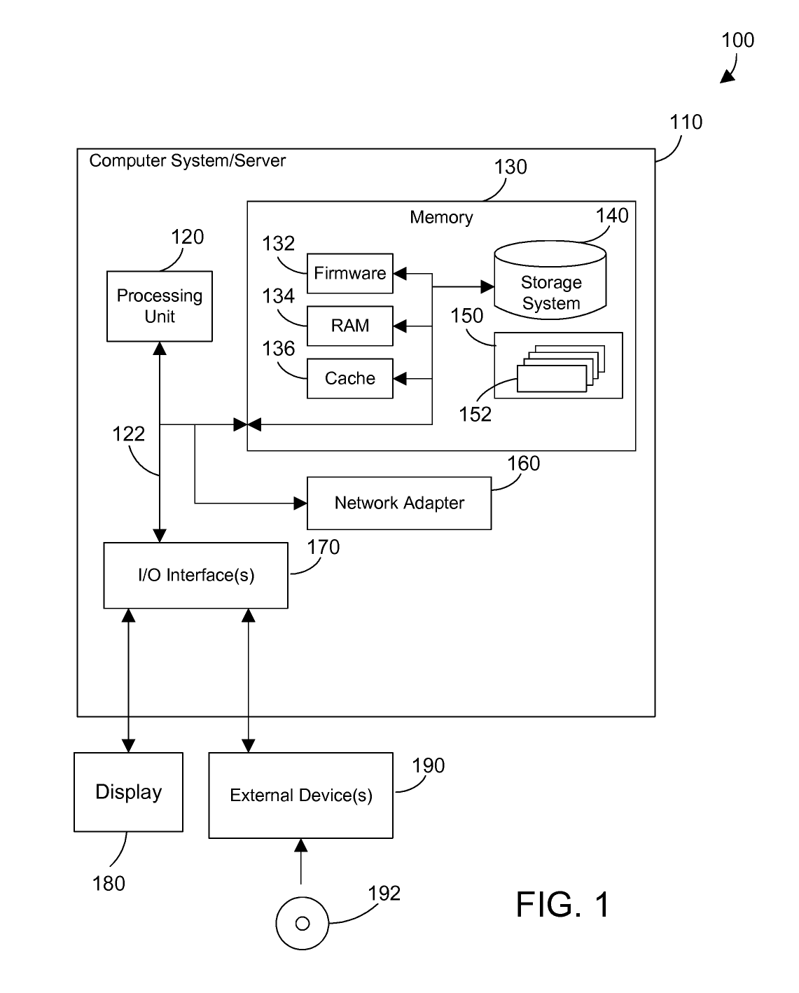

Referring now to FIG. 1, a block diagram of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 110, which is operational with numerous other general purpose or special purpose computing system environments or configurations. Examples of well-known computing systems, environments, and/or configurations that may be suitable for use with computer system/server 110 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 110 may be described in the general context of computer system executable instructions, such as program modules, being executed by a computer system. Generally, program modules may include routines, programs, objects, components, logic, data structures, and so on that perform particular tasks or implement particular abstract data types. Computer system/server 110 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 110 in cloud computing node 100 is shown in the form of a general-purpose computing device. The components of computer system/server 110 may include, but are not limited to, one or more processors or processing units 120, a system memory 130, and a bus 122 that couples various system components including system memory 130 to processor 120.

Bus 122 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 110 typically includes a variety of computer system readable media. Such media may be any available media that is accessible by computer system/server 110, and it includes both volatile and non-volatile media, removable and non-removable media.

System memory 130 can include computer system readable media in the form of volatile, such as random access memory (RAM) 134, and/or cache memory 136. Computer system/server 110 may further include other removable/non-removable, volatile/non-volatile computer system storage media. By way of example only, storage system 140 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 122 by one or more data media interfaces. As will be further depicted and described below, memory 130 may include at least one program product having a set (e.g., at least one) of program modules that are configured to carry out the functions described in more detail below.

Program/utility 150, having a set (at least one) of program modules 152, may be stored in memory 130 by way of example, and not limitation, as well as an operating system, one or more application programs, other program modules, and program data. Each of the operating system, one or more application programs, other program modules, and program data or some combination thereof, may include an implementation of a networking environment. Program modules 152 generally carry out the functions and/or methodologies of embodiments of the invention as described herein.

Computer system/server 110 may also communicate with one or more external devices 190 such as a keyboard, a pointing device, a display 180, a disk drive, etc.; one or more devices that enable a user to interact with computer system/server 110; and/or any devices (e.g., network card, modem, etc.) that enable computer system/server 110 to communicate with one or more other computing devices. Such communication can occur via Input/Output (I/O) interfaces 170. Still yet, computer system/server 110 can communicate with one or more networks such as a local area network (LAN), a general wide area network (WAN), and/or a public network (e.g., the Internet) via network adapter 160. As depicted, network adapter 160 communicates with the other components of computer system/server 110 via bus 122. It should be understood that although not shown, other hardware and/or software components could be used in conjunction with computer system/server 110. Examples, include, but are not limited to: microcode, device drivers, redundant processing units, external disk drive arrays, RAID systems, tape drives, data archival storage systems, etc.

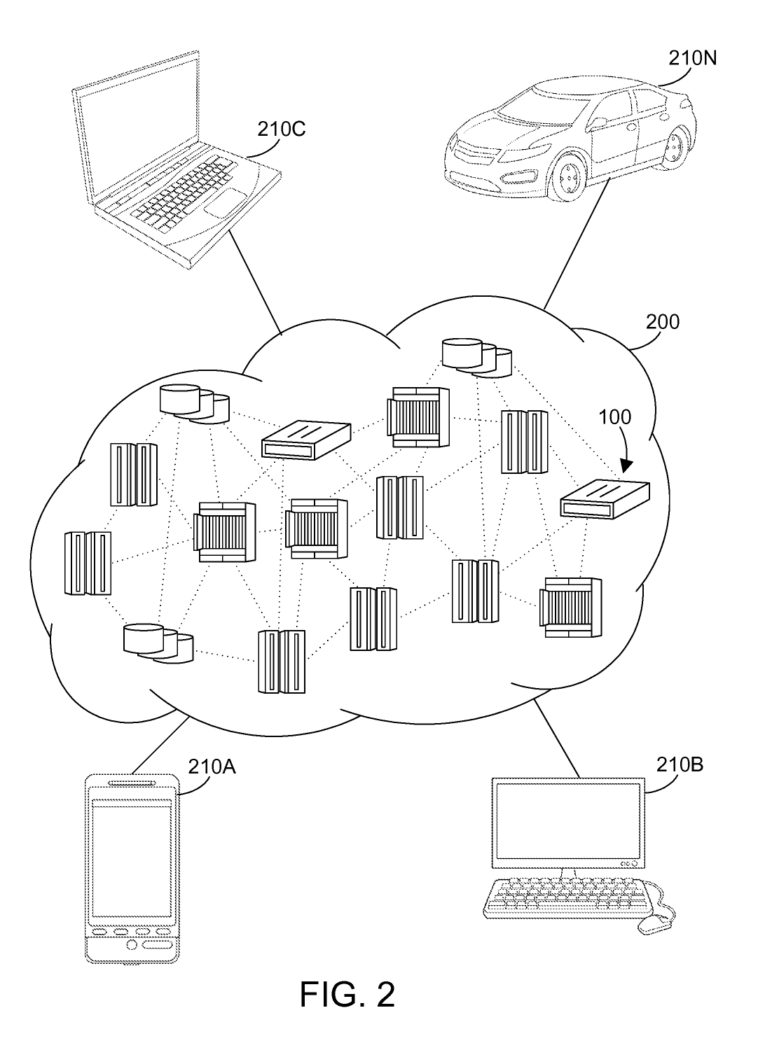

Referring now to FIG. 2, illustrative cloud computing environment 200 is depicted. As shown, cloud computing environment 200 comprises one or more cloud computing nodes 100 with which local computing devices used by cloud consumers, such as, for example, personal digital assistant (PDA) or cellular telephone 210A, desktop computer 210B, laptop computer 210C, and/or automobile computer system 210N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud consumer does not need to maintain resources on a local computing device. It is understood that the types of computing devices 210A-N shown in FIG. 2 are intended to be illustrative only and that computing nodes 100 and cloud computing environment 200 can communicate with any type of computerized device over any type of network and/or network addressable connection (e.g., using a web browser).

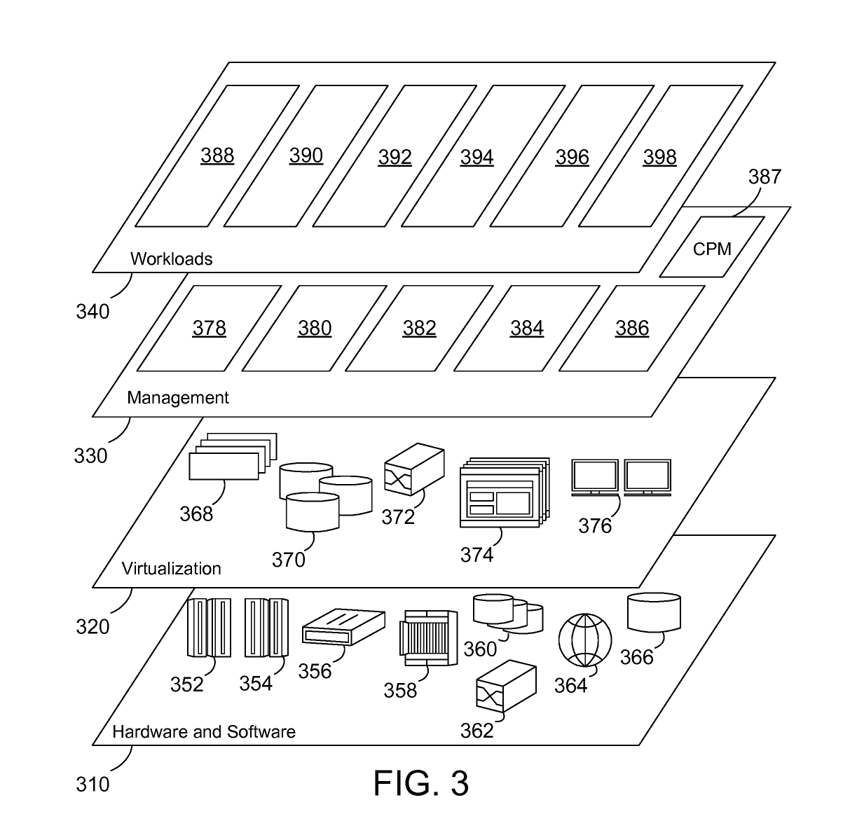

Referring now to FIG. 3, a set of functional abstraction layers provided by cloud computing environment 200 (FIG. 2) is shown. It should be understood in advance that the components, layers, and functions shown in FIG. 3 are intended to be illustrative only and the disclosure and claims are not limited thereto. As depicted, the following layers and corresponding functions are provided.

Hardware and software layer 310 includes hardware and software components. Examples of hardware components include mainframes 352; RISC (Reduced Instruction Set Computer) architecture based servers 354; servers 356; blade servers 358; storage devices 360; and networks and networking components 362. In some embodiments, software components include network application server software 364 and database software 366.

Virtualization layer 320 provides an abstraction layer from which the following examples of virtual entities may be provided: virtual servers 368; virtual storage 370; virtual networks 372, including virtual private networks; virtual applications and operating systems 374; and virtual clients 376.

In one example, management layer 330 may provide the functions described below. Resource provisioning 378 provides dynamic procurement of computing resources and other resources that are utilized to perform tasks within the cloud computing environment. Metering and Pricing 380 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 382 provides access to the cloud computing environment for consumers and system administrators. Service level management 384 provides cloud computing resource allocation and management such that required service levels are met. Service Level Agreement (SLA) planning and fulfillment 386 provide pre-arrangement for, and procurement of, cloud computing resources for which a future requirement is anticipated in accordance with an SLA. A cloud provisioning mechanism 387 provisions cloud resources to a geographical location based on facial recognition, as described in more detail below.

Workloads layer 340 provides examples of functionality for which the cloud computing environment may be utilized. Examples of workloads and functions which may be provided from this layer include: mapping and navigation 388; software development and lifecycle management 390; virtual classroom education delivery 392; data analytics processing 394; transaction processing 396; and mobile desktop 398.

Known solutions for provisioning resources monitor text and other attributes of social media to determine where to provision needed resources. None of the known solutions identify a geographical location for provisioning resources based on facial recognition of a face in a photograph. The preferred embodiments herein provide the advantage of provisioning resources at a location that is determined from a preferred location that is correlated to a person whose face is recognized in a photograph.

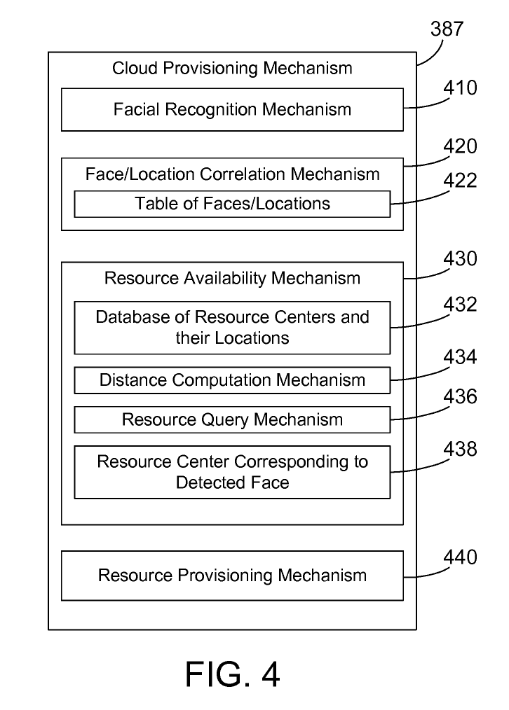

FIG. 4 is a block diagram that shows some of the features of the cloud provisioning mechanism 387 shown in FIG. 3. Cloud provisioning mechanism 387 is software that preferably executes as a program module on a computer system, such as a program module 152 on a cloud computing node 100 shown in FIG. 1. The cloud provisioning mechanism 387 includes a facial recognition mechanism 410, a face/location correlation mechanism 420, a resource availability mechanism 430, and a resource provisioning mechanism 440. The facial recognition mechanism 410 can perform any suitable type of facial recognition using any suitable technology, whether currently known or developed in the future. In one suitable embodiment, the facial recognition mechanism 410 performs facial recognition using known Von Neumann mechanisms. In an alternative embodiment, the facial recognition mechanism 410 performs facial recognition using a neuromorphic processor. International Business Machines Corporation (IBM) has developed a neuromorphic processor known as TrueNorth, which includes one million programmable neurons, 256 million programmable synapses, and 4,096 neurosynaptic cores, while consuming only 1/10 of a watt. Neuromorphic processors such as TrueNorth are well-suited to object recognition in an image, such as facial recognition. One of the principal advantages of neuromorphic processors such as TrueNorth is the speed of performing facial recognition. Traditional Von Neumann mechanisms take considerable processing time to perform facial recognition. A neuromorphic processor, in contrast, can perform facial recognition much faster, typically orders of magnitude faster. This is a considerable advantage for the near real-time processing that is needed to perform facial recognition on photographs that are sent via social media.

A neuromorphic processor is typically trained to perform facial recognition using different sets of photographs. The first set of photographs is a training set. Typically a training set includes many different photographs of the same person, allowing the neuromorphic processor to train itself to look for the facial features in the training set. The second set of photographs is a test set, which includes photographs of the person represented in the training set, and additionally includes photographs of different people as well. The third set of photographs is a verification set, which includes photographs of the person represented in the training set, and additionally includes photographs of different people as well. The results of the facial recognition verification set are compared by a human user to determine whether the results are accurate or not, with the user marking any inaccurate results, such as false positives, so the neuromorphic processor can refine the facial recognition based on the user's input. Once inaccurate results in the verification set have been identified by the user, the neuromorphic processor is ready to perform facial recognition for one person. The process is then repeated for other people, until the neuromorphic processor has been trained to recognize all the faces it needs to recognize.

The face/location correlation mechanism 420 includes a table of faces and locations 422. The table of faces and locations 422 typically includes a list of people for which the facial recognition mechanism 410 has been programmed to recognize faces, along with corresponding locations. The face/location correlation mechanism 420, using the table of faces/locations 422, correlates a recognized face to a corresponding first geographical location, which is a preferred location for the person corresponding to the recognized face.

The resource availability mechanism 430 includes a database of resource centers and their locations 432, a distance computation mechanism 434, and a resource query mechanism 436. The resource availability mechanism 430 queries the database of resource centers and their locations 432 to determine a preferred resource center corresponding to the location specified in the table of faces/locations 422 for a person corresponding to a recognized face. In the most preferred embodiment, the preferred resource center is the resource center at a second geographical location that is the closest to the first geographical location specified in the table of faces/locations 422 for the person corresponding to the recognized face. The distance computation mechanism 434 computes distance between the first geographical location specified in the table of faces/locations 422 and the second geographical location corresponding to the preferred resource center. The resource query mechanism 436 queries the preferred resource center to determine whether the preferred resource center has the resources needed. If so, the resource availability mechanism 430 identifies the resource center corresponding to the detected face 438, which is at the second geographical location. Once the resource center corresponding to the detected face 438 is identified, the resource provisioning mechanism 440 can provision the needed resources from the resource center corresponding to the detected face 438.

The distance computation mechanism 434 can compute distance between a resource center and the location corresponding to a recognized face in the table of faces/locations 422 using any suitable method. For example, the Cartesian calculation of distance formula:

d=\sqrt{(x₂−x₁)²+(y₂−y₁)²}

where d is the distance and x₁ and y₁ are the Cartesian coordinates of one location and x₂ and y₂ are the Cartesian coordinates of the other location. The Manhattan calculation of distance formula:

$$d = {\sum }_{i = 1}^{n} \vert {x}_{i} - {y}_{i} \vert$$

where d is the distance, and is the sum of the absolute difference between the xᵢ and yᵢ components. The Chebychev calculation of distance formula:

d=Maxᵢ|xᵢ−yᵢ|

where d is the distance, and is the greatest of the absolute distance between the difference of any xᵢ and yᵢ component. Note the computation of distance can be between any two points regardless of how those points are determined. For example, if a player's country of origin is the preferred location, the distance can be computed from the capital of the country, from a border of the country, from the most populated city in the country, from a computed geographical center of the country, etc. The disclosure and claims herein apply to any and all different manners for computing distance between a resource center and the location corresponding to a recognized face, whether currently known or developed in the future.

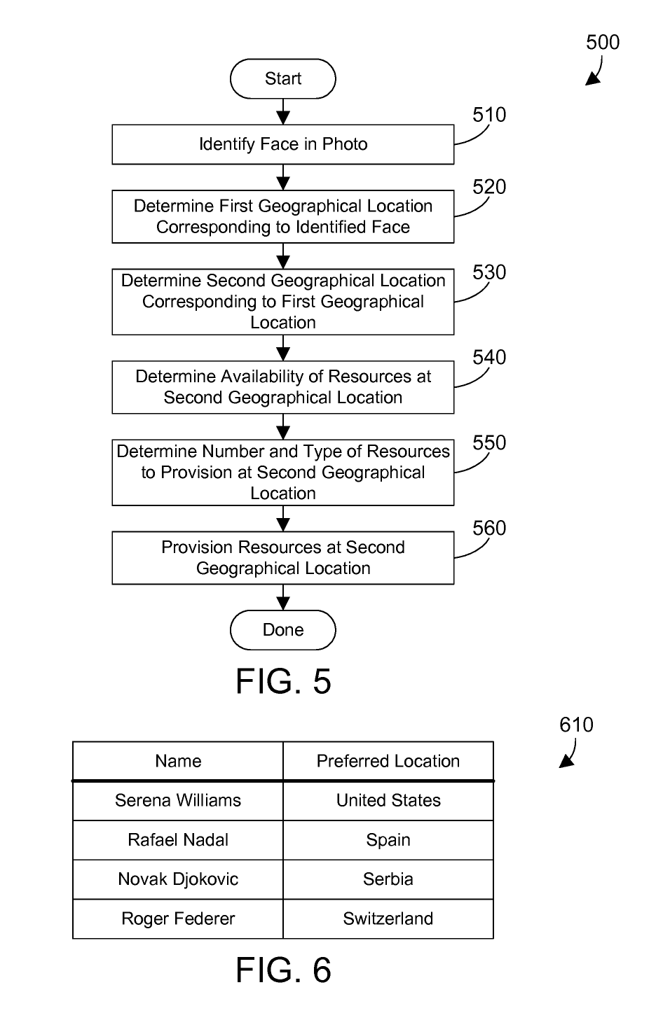

Referring to FIG. 5, a method 500 represents steps that are preferably performed by the cloud provisioning mechanism 387 shown in FIGS. 3 and 4 when executed by one or more processors. First, a face in a photograph is identified (step 510). This identification of the face in step 510 is preferably performed by the facial recognition mechanism 410 shown in FIG. 4. In one specific implementation, the identifying of a face in a photograph in step 510 means the name of the person corresponding to the face is identified. In one specific implementation, the identifying of a face in a photograph in step 510 is performed on a photograph in a social media message. A first geographical location corresponding to the identified face is determined (step 520). Step 520 is preferably performed by the face/location correlation mechanism 420 in FIG. 4. A second geographical location corresponding to the first geographical location is determined (step 530). Step 530 is preferably performed by the resource availability mechanism 430 in FIG. 4. The determination of the second geographical location is most preferably done based on distance, with the second geographical location being a resource center that is the shortest distance from the first geographical location. When there are resources available at the first geographical location, the first and second geographical locations will be the same. However, in many instances the first and second geographical locations will be different when the first geographical location does not have a resource center with the needed resources. The availability of resources at the second geographical location is determined (step 540). If the second geographical location does not have available resources as determined in step 540, a different second geographical location would be selected, preferably the next closest resource center. Once a second geographical location with available resources is found, the number and type of resources to provision at the second geographical location is determined (step 550). These resources are then provisioned at the second geographical location (step 560). Method 500 is then done. In the most preferred implementation, the resources are cloud resources, such as virtual machines, and the provisioning in step 560 means provisioning cloud resources to a cloud resource center, sometimes called a cloud plex, at the second geographical location.

Determining the first geographical location corresponding to an identified face could be done using a table of faces/locations 422 as shown in FIG. 4. Table 610 in FIG. 6 is one suitable implementation for table of faces/locations 422 shown in FIG. 4 for the four professional tennis players shown. Serena Williams has a preferred location of United States. Rafael Nadal has a preferred location of Spain. Novak Djokovic has a preferred location of Serbia. Roger Federer has a preferred location of Switzerland. Note the preferred locations in FIG. 6 are the countries of origin for each of these players. It is reasonable to expect that people in a player's home county will be interested in how the player from their country is doing. This can create a need for more resources near the player's home country. By correlating people to preferred locations as shown in table 610 in FIG. 6, the first geographical location can be determined in step 520 by querying the table 610.

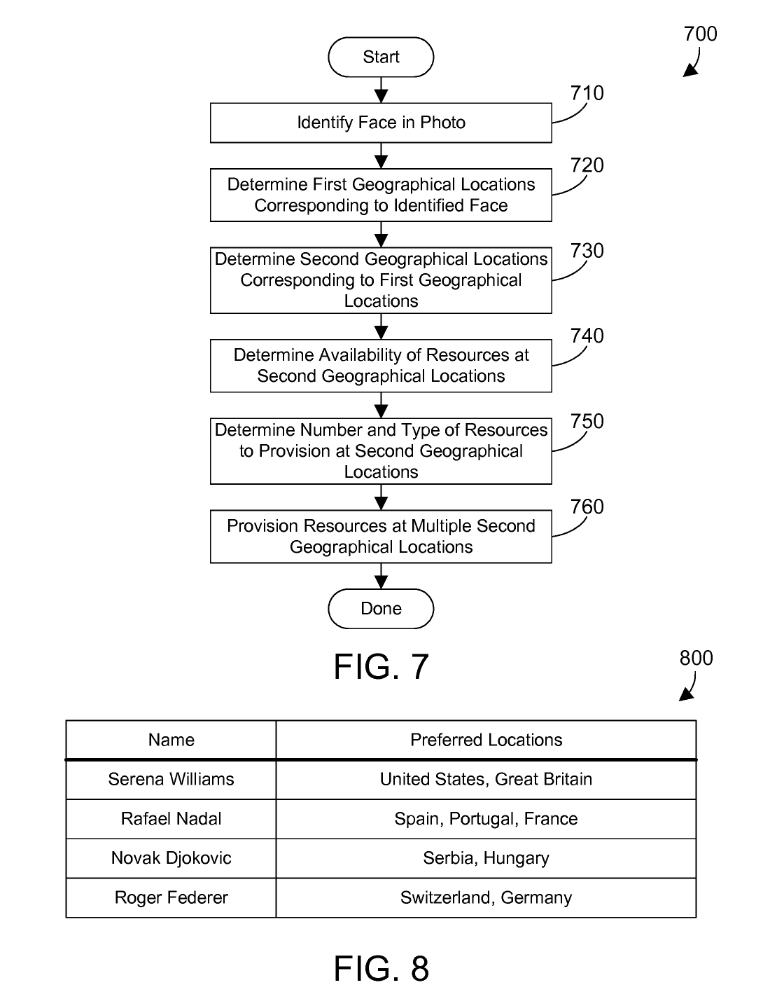

Identifying a face in a photograph can result in provisioning resources to multiple locations. Referring to FIG. 7, method 700 identifies a face in a photograph (step 710). Multiple first geographical locations corresponding to the identified face are determined (step 720). Multiple second geographical locations that correspond to the multiple first geographical locations are determined (step 730). The availability of resources at each of the second geographical locations is determined (step 740). The number and type of resources to provision at each of the second geographical locations is determined (step 750). Resources are then provisioned at the multiple second geographical locations (step 760). Method 700 is the done.

A table 800 is shown in FIG. 8 that is one specific implementation of the table of faces/locations 422 shown in FIG. 4. Each player in table 800 has multiple preferred locations, which are the first geographical locations referenced in step 720. For the specific example in FIG. 8, Serena Williams has preferred locations of Unites States and Great Britain. Rafael Nadal has preferred locations of Spain, Portugal and France. Novak Djokovic has preferred locations of Serbia and Hungary. Roger Federer has preferred locations of Switzerland and Germany. The specific example shown in FIGS. 7 and 8 shows how resources could be deployed at multiple different geographical locations based on the identified face in a photograph.

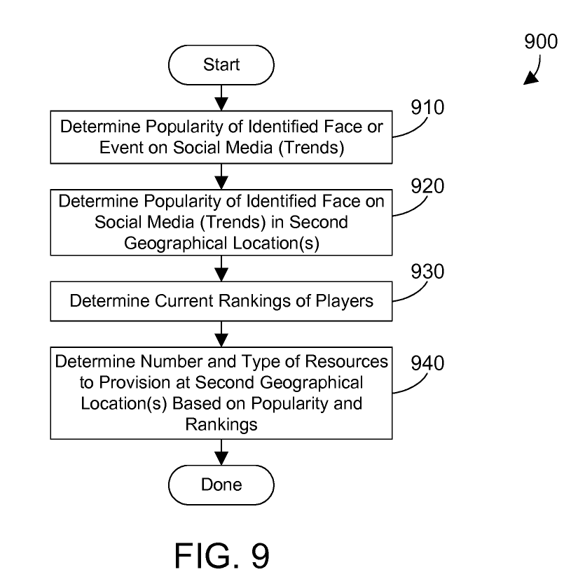

The number and type of resources determined in step 550 in FIG. 5 and step 750 in FIG. 7 can be performed in any suitable way. One specific way is shown as method 900 in FIG. 9. The popularity of the identified face or an event corresponding to the identified face on social media is determined (step 910). In social media parlance, step 910 determines whether the person or event corresponding to the identified face is trending on social media. Note that step 910 can determine popularity of a person, such as a tennis player, or an event, such as Wimbledon. Next, the popularity of the person corresponding to the identified face on social media in one or more second geographical locations is determined (step 920). The current rankings of the players are determined (step 930). The number and type of resources to provision at the second geographical location(s) is determined (step 940) based on the popularity on social media determined in steps 910 and 920 and based on the rankings in step 930. Method 900 illustrates how different factors, such as popularity on social media and rankings, may be used to determine which resources to provision at the second geographical location(s) based on an identified face.

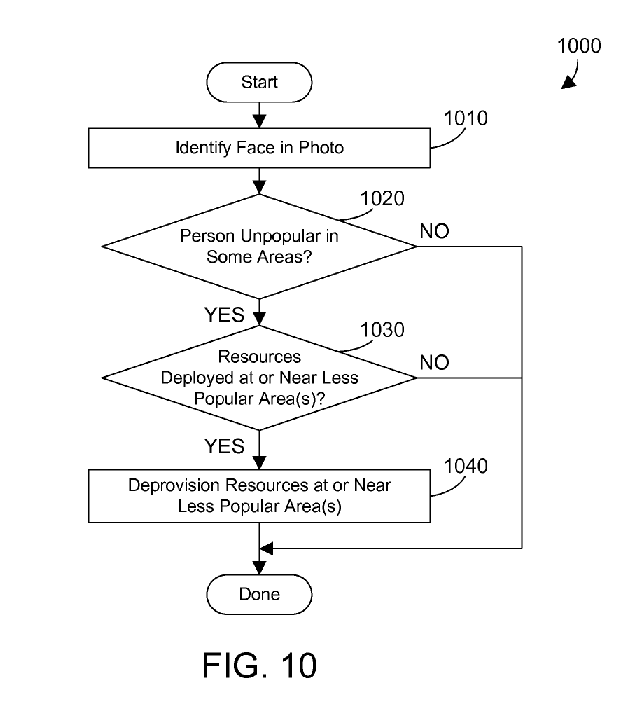

In addition to provisioning resources in locations that correspond to an identified face in a photograph, the cloud provisioning mechanism 387 can also deprovision resources based on an identified face in a photograph. Referring to FIG. 10, a face in a photograph is identified (step 1010). If the identified face is of a person who is unpopular in some areas (step 1020=YES), and if there are resources deployed at or near one or more less popular areas (step 1030=YES), resources at or near the less popular area(s) are deprovisioned (step 1040). If the person is not unpopular in some areas (step 1030=NO) or if the person is unpopular in some areas (step 1030=YES) but there are no resources deployed at or near the less popular areas (step 1030=NO), method 1000 is done.

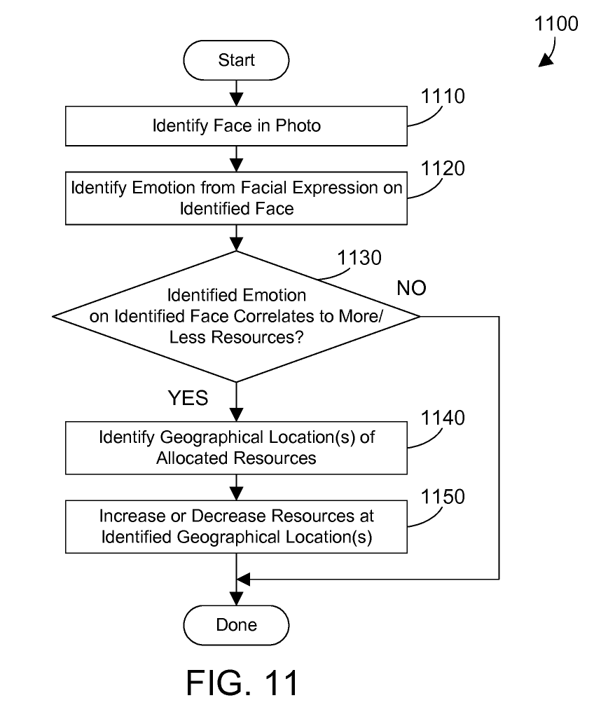

In one embodiment, in addition to basic facial recognition that identifies a person to a face in a photograph, the facial recognition mechanism 410 in FIG. 4 can also identify emotions based on facial expression. Referring to FIG. 11, method 1100 begins by identifying a face in a photograph (step 1110). When possible, an emotion is identified from the facial expression on the identified face (step 1120). When the identified emotion does not correlate to more or less resources (step 1130=NO), method 1000 is done. When the identified emotion correlates to more or less resources (step 1130), one or more geographical locations of allocated resources are identified (step 1140) and resources at the identified geographical location(s) are increased or decreased (step 1150). Method 1100 illustrates that an emotion on a face of a person in a photograph can be used to increase or decrease resources according to the identified emotion.

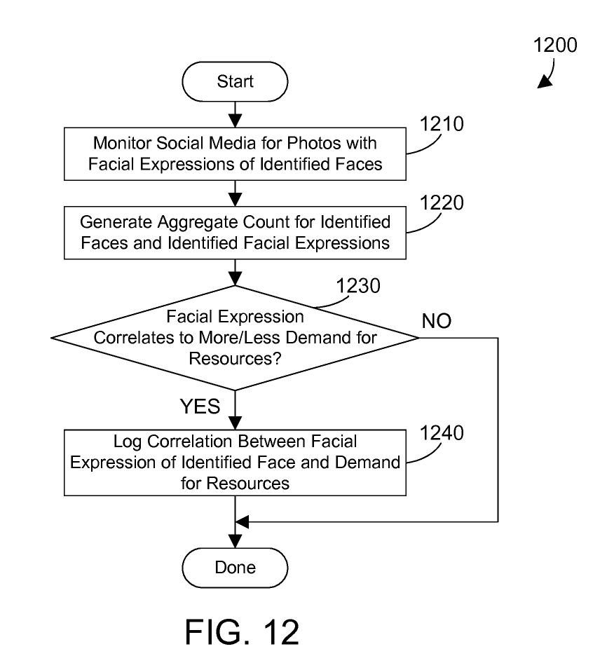

Referring to FIG. 12, a method 1200 shows how facial expressions may be correlated to increased or decreased demand for resources. Social media is monitored for photos with facial expressions of identified faces (step 1210). An aggregate count is generated for the identified faces and the identified facial expressions (step 1220). When a facial expression does not correlate to more or less demand for resources (step 1230=NO), method 1200 is done. When a facial expression correlates to more or less demand for resources (step 1230=YES), the correlation between the facial expression of the identified face and the demand for resources is logged (step 1240). Method 1200 is then done. Once the correlation between facial expression and demand for resources is logged in step 1240, step 1130 in FIG. 11 can query the log to determine whether the identified emotion on the identified face correlates to more or less resources.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A provisioning mechanism performs facial recognition of a photograph, and determines when the person corresponding to the recognized face is correlated to a desired geographical location. The availability of resources near the desired geographical location is determined, and computer resources are then provisioned at a resource center near the desired geographical location. The result is provisioning computer resources to a geographical location based on facial recognition.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
at least one processor;
a memory coupled to the at least one processor;
a provisioning mechanism residing in the memory and executed by the at least one processor, the provisioning mechanism comprising:
a facial recognition mechanism that recognizes a face in a photograph;
a face/location correlation mechanism that correlates the face recognized by the facial recognition mechanism to a corresponding first geographical location;
a resource availability mechanism that identifies a resource center at a second geographical location that correlates with the first geographical location and has resources available; and
a resource provisioning mechanism that provisions at least one resource to the resource center at the second geographical location.

2. The apparatus of claim 1 wherein the face/location correlation mechanism correlates the face to a corresponding country of origin for a person corresponding to the face, wherein the first geographical location is within the country of origin.

3. The apparatus of claim 1 wherein the facial recognition mechanism comprises a neuromorphic processor.

4. The apparatus of claim 1 wherein the second geographical location is at a shortest distance between the first geographical location and any resource center that has resources available.

5. The apparatus of claim 1 wherein the resource provisioning mechanism determines number and type of resources to provision based on current popularity of a person corresponding to the face on social media.

6. The apparatus of claim 1 wherein the provisioning mechanism determines a person corresponding to the face is unpopular in at least one geographical area, and deprovisions at least one resource in a geographical location corresponding to the at least one geographical area.

7. The apparatus of claim 1 wherein the facial recognition mechanism identifies an emotion from facial expression of the face in the photograph, and the provisioning mechanism determines whether the identified emotion correlates to more or less resources, and when the identified emotion correlates to more resources, the provisioning mechanism provisions at least one additional resource at the second geographical location, and when the identified emotion correlates to less resources, the provisioning mechanism deprovisions at least one resource at the second geographical location.

8. A computer-implemented method executed by at least one processor for provisioning computer resources, the method comprising:
recognizing a face in a photograph;
correlating the recognized face to a corresponding first geographical location;
identifying a resource center at a second geographical location that correlates with the first geographical location and has resources available; and
provisioning at least one resource to the resource center at the second geographical location.

9. The method of claim 8 wherein correlating the recognized face to the first geographical location comprises correlating the recognized face to a corresponding country of origin for a person corresponding to the face, wherein the first geographical location is within the country of origin.

10. The method of claim 8 wherein recognizing the face in the photograph is performed by a neuromorphic processor.

11. The method of claim 8 wherein the second geographical location is at a shortest distance between the first geographical location and any resource center that has resources available.

12. The method of claim 8 further comprising determining number and type of resources to provision based on current popularity of a person corresponding to the face on social media.

13. The method of claim 8 further comprising:
determining a person corresponding to the face is unpopular in at least one geographical area; and
deprovisioning at least one resource in a geographical location corresponding to the at least one geographical area.

14. The method of claim 8 further comprising:
identifying an emotion from facial expression of the face in the photograph;
determining whether the identified emotion correlates to more or less resources;
when the identified emotion correlates to more resources, provisioning at least one additional resource at the second geographical location; and
when the identified emotion correlates to less resources, deprovisioning at least one resource at the second geographical location.

15. An article of manufacture comprising software stored on a non-transitory computer readable storage medium, the software comprising:
a provisioning mechanism comprising:
a facial recognition mechanism that recognizes a face in a photograph;
a face/location correlation mechanism that correlates the face recognized by the facial recognition mechanism to a corresponding first geographical location;
a resource availability mechanism that identifies a resource center at a second geographical location that correlates with the first geographical location and has resources available; and
a resource provisioning mechanism that provisions at least one resource to the resource center at the second geographical location.

16. The article of manufacture of claim 15 wherein the face/location correlation mechanism correlates the face to a corresponding country of origin for a person corresponding to the face, wherein the first geographical location is within the country of origin.

17. The article of manufacture of claim 15 wherein the second geographical location is at a shortest distance between the first geographical location and any resource center that has resources available.

18. The article of manufacture of claim 15 wherein the resource provisioning mechanism determines number and type of resources to provision based on current popularity of a person corresponding to the face on social media.

19. The article of manufacture of claim 15 wherein the provisioning mechanism determines a person corresponding to the face is unpopular in at least one geographical area, and deprovisions at least one resource in a geographical location corresponding to the at least one geographical area.

20. The article of manufacture of claim 15 wherein the facial recognition mechanism identifies an emotion from facial expression of the face in the photograph, and the provisioning mechanism determines whether the identified emotion correlates to more or less resources, and when the identified emotion correlates to more resources, the provisioning mechanism provisions at least one additional resource at the second geographical location, and when the identified emotion correlates to less resources, the provisioning mechanism deprovisions at least one resource at the second geographical location.
